(19) United States
(12) Patent Application Publication
(10) Pub. No.: US 2024/0217485 A1
(43) Pub. Date: Jul. 4, 2024

(54) METHOD FOR CONTROLLING A PUMP FOR CLEANING SENSORS OF A VEHICLE

(71) Applicant: Valeo Systemes d'Essuyage, La Verriere (FR)

(72) Inventor: Denis THEBAULT, La Verriere (FR)

(73) Assignee: Valeo Systemes d'Essuyage, La Verriere (FR)

(21) Appl. No.: 18/553,872

(22) PCT Filed: Mar. 7, 2022
(86) PCT No.: PCT/EP2022/055684

§ 371 Date: Oct. 4, 2023

(30) Foreign Application Priority Data
Apr. 14, 2021 (FR) FR2103826

(51) Int. Cl. B60S 1/48; B60S 1/08; B60S 1/56

(52) U.S. Cl. CPC B60S 1/481; B60S 1/0818; B60S 1/56

(57) ABSTRACT

The invention relates to a method for controlling a cleaning pump for cleaning sensors of a vehicle, said control method comprising the steps of: receiving at least one request to clean at least one sensor of said vehicle, determining a flow rate of cleaning fluid as a function of said at least one cleaning request, adapting the supply voltage of said cleaning pump as a function of said flow rate of cleaning fluid by means of a pulse-width modulation signal so as to provide a predetermined pressure for said flow rate of cleaning fluid and to send said cleaning fluid at said pressure into a spray nozzle associated with said at least one sensor.

### TECHNICAL FIELD

The present invention relates to a method for controlling a pump for cleaning sensors of a vehicle. It is particularly applicable in motor vehicles, but is not limited thereto.

### BACKGROUND OF THE INVENTION

In the field of motor vehicles, notably in autonomous or semi-autonomous motor vehicles, there are several sensors such as lidars, radars or even cameras. For autonomous or semi-autonomous driving to be as efficient and as reliable as possible, the information provided by the sensors must be of the highest possible quality. Therefore, it is essential that the external surfaces of these sensors are kept clean. Thus, said external surfaces need to be able to be frequently washed when they are dirty. To this end, a method for controlling pumps for cleaning sensors of a vehicle exists, which is known to a person skilled in the art and which controls low-pressure washing pumps intended for washing windscreens with a low pressure ranging between 2-3 bar. This control method controls several low-pressure pumps in series in order to obtain a higher pressure of between 6-8 bar so that several sensors, ten or more, can be washed simultaneously.

One disadvantage of this prior art is that, due to the plurality of sensors, the low-pressure pumps are used much more often than for washing a windscreen. Therefore, they wear out more quickly. In addition, as they are not originally configured to operate in series and to receive a pressurized cleaning fluid as input that originates from another pump arranged upstream, there is a significant risk of breakage.

### BRIEF SUMMARY OF THE INVENTION

In this context, the aim of the present invention is to propose a method for controlling a pump for cleaning sensors for a vehicle that allows the aforementioned disadvantages to be addressed.

To this end, the invention proposes a method for controlling a pump for cleaning sensors of a vehicle, said control method comprising the following steps:
receiving at least one cleaning request from at least one sensor of said vehicle;
determining a flow rate of cleaning fluid as a function of said at least one cleaning request;
adapting the supply voltage of said cleaning pump as a function of said flow rate of cleaning fluid, by means of a pulse width modulation signal so as to provide a predetermined pressure for said flow rate of cleaning fluid and to send said cleaning fluid at said predetermined pressure into a spray nozzle associated with said at least one sensor.

Thus, by virtue of this control method, it is no longer necessary to use low-pressure cleaning pumps that are not suitable for cleaning several sensors at the same time. Therefore, a high-pressure cleaning pump is used.

According to non-limiting embodiments, said control method can further comprise one or more additional features, taken alone or in any technically possible combination, from among the following.

According to one non-limiting embodiment, the step of adapting the supply voltage occurs based on a chart of various pressures per flow rate.

According to one non-limiting embodiment, when the pulse width modulation signal has a duty cycle of 100%, the supply voltage of said cleaning pump corresponds to the voltage of the battery of the vehicle.

According to one non-limiting embodiment, the supply voltage is also adapted as a function of at least one ambient condition. According to one non-limiting example, said at least one ambient condition is the outside temperature.

According to one non-limiting embodiment, said at least one sensor is a lidar, a radar or a camera.

According to one non-limiting embodiment, the predetermined pressure is determined as a function of at least one static parameter.

According to one non-limiting embodiment, said at least one static parameter is a distance between a spray nozzle and a sensor with which it is associated, a washing quality, the nature of the sensors, the total number of sensors.

According to one non-limiting embodiment, the predetermined pressure ranges between 6 bar and 8 bar.

A computer program product is also proposed comprising instructions, which, when the program is executed by a computer, cause said computer to implement the steps of the control method according to any one of the preceding features.

A non-transitory computer-readable storage medium is also proposed comprising instructions, which, when they are executed by a computer, cause the computer to execute the control method according to any one of the preceding features.

A system for cleaning sensors of a vehicle is also proposed, comprising:
at least one cleaning pump;
a plurality of spray nozzles;
a drive control unit, characterized in that said drive control unit is configured for:
receiving at least one cleaning request from at least one sensor of said vehicle;
determining a cleaning fluid flow rate as a function of said at least one request;
adapting the supply voltage of said cleaning pump as a function of said cleaning fluid flow rate, by means of a pulse width modulation signal so as to provide a predetermined pressure for said cleaning fluid flow rate and to send said cleaning fluid at a predetermined pressure for said flow rate into a spray nozzle associated with said at least one sensor.

According to one non-limiting embodiment, the drive control unit is further configured to control the opening of a solenoid valve associated with said spray nozzle to allow said cleaning fluid to pass through a pipe connected to said spray nozzle.

### BRIEF DESCRIPTION OF THE DRAWINGS

The invention and the various applications thereof will be better understood upon reading the following description and with reference to the accompanying figures, in which:

FIG. 1 is a flow chart of a method for controlling a pump for cleaning sensors of a vehicle, according to one non-limiting embodiment of the invention;

FIG. 2 illustrates a non-limiting example of a first chart used by the control method of FIG. 1 to adapt the supply voltage of the cleaning pump, according to one non-limiting embodiment;

FIG. 3 is a schematic view of a system for cleaning sensors of a vehicle, according to one non-limiting embodiment of the invention;

FIG. 4 illustrates a non-limiting example of a second chart indicating the current consumption of a cleaning pump controlled by the control method of FIG. 1, according to one non-limiting embodiment.

### DETAILED DESCRIPTION OF THE INVENTION

Identical elements, by structure or by function, that appear in the various figures use the same reference signs, unless otherwise specified.

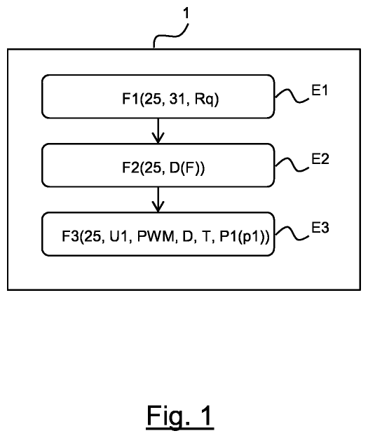

The control method 1 for controlling a cleaning pump 2 for cleaning sensors 31 of a vehicle 3 according to the invention is illustrated in FIG. 1. In one non-limiting embodiment, the vehicle 3 is a motor vehicle. A motor vehicle is understood to mean any type of motorized vehicle. This embodiment is taken as a non-limiting example throughout the remainder of the description. Throughout the remainder of the description, the vehicle 3 is thus also called motor vehicle 3. In non-limiting embodiments, the motor vehicle 3 is an autonomous or semi-autonomous vehicle.

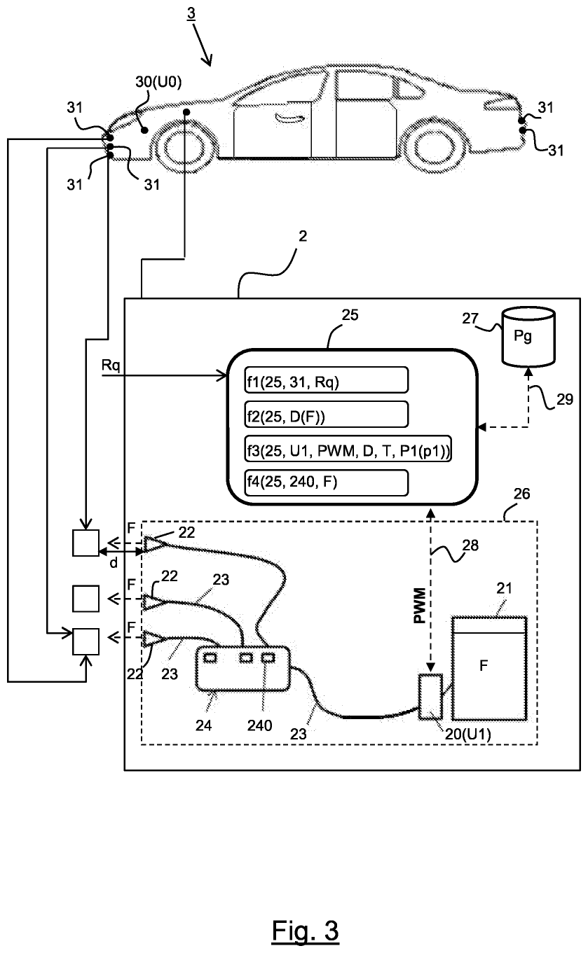

As illustrated in FIG. 3, the motor vehicle 3 comprises a battery 30 and at least one sensor 31. In one non-limiting example, the battery 30 supplies a voltage U0 of 15 V (Volts). In non-limiting embodiments, the sensor 31 is a lidar, a radar or a camera. The sensor 31 comprises an external surface to be cleaned. In the case of a radar, this external surface is traversed by transmitted radar waves and return radar waves received by the radar. In the case of a lidar, this external surface is traversed by a transmitted laser beam and return waves received by the lidar. In the case of a camera, this external surface represents the external surface of the optic of the camera. The sensor 31 comprises a visibility threshold, beyond which it cannot operate correctly because its external surface is too dirty. When this visibility threshold is reached, the sensor 31 is configured to feedback information indicating that its visibility threshold has been reached, by means of a cleaning request Rq.

In one non-limiting embodiment, the motor vehicle 3 comprises a plurality of sensors 31. This non-limiting embodiment is taken as a non-limiting example throughout the remainder of the description. In one non-limiting example, it comprises around ten sensors 31. In FIG. 3, only five sensors 31 are shown, three at the front and two at the rear. Of course, it should be noted that sensors 31 also can be arranged on the sides of the motor vehicle 3. The sensors 31 are configured to provide information relating to the external environment of the motor vehicle 3, which information is used to carry out functions for autonomous or semi-autonomous driving in particular. In non-limiting examples, this information is images of the external environment, the presence of a static or moving object in front of, behind or to the side of the motor vehicle 3.

Depending on the level of autonomy of the vehicle, in non-limiting examples these functions include:
emergency braking assistance;
automatic parking with steering management;
adaptive cruise control without driver intervention;
vehicle steering (longitudinal and transverse trajectory control, keeping the vehicle in its lane and adapting its speed to the flow of traffic);
vehicle movement management on motorways and roads with visible road markings;
vehicle control without driver intervention.

As illustrated in FIG. 3, the motor vehicle 3 comprises a cleaning system 2 comprising, in one non-limiting embodiment:
at least one cleaning pump 20 for cleaning sensors 31 configured to route a cleaning fluid F through pipes 23 up to spray nozzles 22;
at least one storage tank 21 configured to store the cleaning fluid F;
a plurality of spray nozzles 22 configured to deliver the cleaning fluid F onto the external surfaces of the sensors 31;
a plurality of pipes 23 configured to convey the cleaning fluid F from said at least one storage tank 21 up to the spray nozzles 22;
a distribution module 24 comprising a plurality of solenoid valves 240 configured to distribute the cleaning fluid F to the sensors 31;
a drive control unit 25 configured to drive said at least one cleaning pump 20 and said plurality of solenoid valves 240.

In one non-limiting example, the cleaning fluid F is an antifreeze windscreen washer fluid. The cleaning pump 20, the tank 21, the plurality of pipes 23 and the distribution module 24 form a distribution circuit 26 for the cleaning fluid F. In one non-limiting embodiment, the motor vehicle 3 comprises two distribution circuits 26, one arranged at the front and one arranged at the rear of the motor vehicle 3. This allows the plurality of sensors 31 located at the front and at the rear of the motor vehicle 3, for example, to be washed simultaneously. Thus, in this non-limiting embodiment, the motor vehicle 3 comprises two storage tanks 21, one arranged at the front and one arranged at the rear, and two cleaning pumps 2, one arranged at the front and one arranged at the rear. Each cleaning pump 20 is located directly at the output of one of the storage tanks 21. In FIG. 3, only one distribution circuit 26 has been illustrated. When the motor vehicle 3 comprises two distribution circuits 26, in this case the drive control unit 25 is configured to control the two cleaning pumps 20 and said plurality of solenoid valves 240 of the two distribution circuits 26.

A spray nozzle 22 is associated with a sensor 31. Thus, there are as many spray nozzles 22 as there are sensors 31. A spray nozzle 31 is disposed in the vicinity of the sensor 31 with which it is associated. Its distance d from the sensor 31 depends on the external surface of the sensor 31 to be cleaned. The smaller the external surface of the sensor 31, the closer the spray nozzle 22 is positioned to the sensor 31. In one non-limiting embodiment, the distance d ranges between 1 cm (centimeters) and 10 cm. In one non-limiting example, for a sensor 31 with a diameter of 15 mm (millimeters), such as a wide-angle camera, the distance d is 1 cm. In one non-limiting example, for a sensor 31 with dimensions of 20 cm-5 cm, such as a lidar, the distance d is 5 cm. In one non-limiting example, a spray nozzle 22 has an activation time ranging between 50 ms (millisecond) and 500 ms maximum. This activation time is the opening time to allow through the cleaning fluid F. It therefore represents the time for spraying the cleaning fluid F onto the sensor 31. It should be noted that this time is relatively short to avoid blocking the operation of the sensor 31 for too long. Indeed, during cleaning, a camera 31 cannot capture images, for example. In addition, the activation time is relatively short to ensure reasonable consumption of the cleaning fluid F.

It should be noted that a spray nozzle 22 is associated with a solenoid valve 240. Thus, the distribution module 24 comprises as many solenoid valves 240 as spray nozzles 22, so that the delivery of the cleaning fluid F by a given spray nozzle 22 is governed by the control of only one solenoid valve 240. The solenoid valves 240 are controlled by the drive control unit 25.

The cleaning pump 20 is a high-pressure cleaning pump. In one non-limiting embodiment, it allows a pressure P1 to be supplied that ranges between 6 and 8 bar for a flow rate D of cleaning fluid F. In one non-limiting embodiment, the cleaning pump 20 is an electronic pump governed by an electric motor. In one non-limiting embodiment, the electric motor is a brushless motor. This guarantees the reliability of the cleaning pump 20 compared with a cleaning pump with a brushed electric motor. The cleaning pump 20 is powered by a supply voltage U1. The supply voltage U1 of the cleaning pump 20 can be modified on the basis of a pulse width modulation (PWM) signal. This allows the speed of rotation of the electric motor to be modified. Modifying the speed of rotation modifies the pressure of the cleaning fluid F output from the cleaning pump 20. Notably, increasing the speed of rotation leads to an increase in the pressure of the cleaning fluid F. It is thus possible to adapt the pressure of the cleaning fluid F output from the cleaning pump 20 so that said pump provides a predetermined pressure P1 to send said cleaning fluid F into a spray nozzle 22 at a given flow rate D.

It should be noted that the pressure P1 is determined by the car manufacturers or by the designers of the cleaning system 2 as a function of the architecture of the cleaning system 2. It is therefore predetermined since it is determined upstream, i.e., before the cleaning pump 20 is used. The pressure P1 is determined irrespective of the number of sensors 31 to be cleaned. Thus, it does not depend on the number of sensors 31 to be cleaned. In one non-limiting example that is used throughout the remainder of the description, the pressure P1 is 6 bar. In one non-limiting embodiment, the pressure P1 is determined as a function of at least one static parameter p1, i.e., a parameter that does not change as the motor vehicle 3 travels and as the operations for cleaning the sensors 31 progress, as opposed to a dynamic parameter. In non-limiting examples, said at least one static parameter p1 is the distance d between a spray nozzle 22 and the sensor 31 with which it is associated, the desired washing quality, the nature of the sensors 31, or even the total number of sensors 31. Thus, the pressure P1 can be determined as a function of one or more static parameters p1.

The cleaning pump 20 is controlled by the control method 1 that is described in detail hereafter in one non-limiting embodiment with reference to FIG. 1. Control is carried out by the drive control unit 25 of the cleaning system 2. In one non-limiting embodiment, it is carried out via a data bus 28 that connects the drive control unit 25 to the cleaning pump 20. In one non-limiting example, the data bus 28 is a LIN (Local Interconnect Network) data bus.

As illustrated in FIG. 1, the control method 1 comprises the following steps.

In a step E1 illustrated F1 (25, 31, Rq), the drive control unit 25 receives at least one cleaning request Rq from at least one sensor 31 of the motor vehicle 3. Indeed, a sensor 31 is configured to send such a cleaning request Rq when it is dirty, i.e., its external surface is dirty. In one non-limiting embodiment, the drive control unit 25 receives a plurality of cleaning requests Rq from N sensors 31, with N=1 to m, where m is an integer. In one non-limiting example that is used throughout the remainder of the description, five sensors 31 are to be simultaneously cleaned. Thus, the electronic control unit 25 receives five cleaning requests Rq from each of the five sensors 31 to be cleaned.

In a step E2 illustrated F2 (25, D(F)), the drive control unit 25 determines a flow rate D of cleaning fluid F as a function of said at least one cleaning request Rq. Thus, the flow rate D is determined as a function of the number N of received cleaning requests Rq and therefore as a function of the total number of sensors 31 to be simultaneously cleaned. Therefore, a total flow rate is determined. Thus, in the non-limiting example of five sensors 31, the electronic control unit 25 determines a flow rate D of cleaning fluid F as a function of the five received cleaning requests Rq. In one non-limiting example, the flow rate D required for a single sensor 31 is 8 mL/s (milliliter/second). This flow rate D per sensor 31 is determined when the cleaning system 2 is designed. It is determined so as to have a good cleaning efficiency-to-consumption of cleaning fluid F ratio. In the non-limiting example of five sensors 31, in order to clean the five sensors 31 simultaneously, the total flow rate D is therefore 40 mL/s. In another non-limiting example, in order to clean two sensors 31 simultaneously, the total flow rate D therefore will be 16 mL/s.

In a step E3 illustrated F3 (25, U1, PWM, D, T, P1(p1)), the drive control unit 25 adapts the supply voltage U1 of said cleaning pump 20 as a function of said flow rate D of cleaning fluid F, by means of a pulse width modulation (PWM) signal so as to supply the predetermined pressure P1 in order to obtain said flow rate D of cleaning fluid F and to send said cleaning fluid F at said pressure P1 into a spray nozzle 22 associated with said at least one sensor 31. Thus, in the non-limiting example of five sensors 31, the cleaning fluid F is sent into the spray nozzles 22 at a pressure P1 of 6 bar for a total flow rate D of 40 mL in order to simultaneously clean the five sensors 31.

When a pulse width modulation (PWM) signal (with a duty cycle greater than 0) is applied to the cleaning pump 20, this starts said cleaning pump 20 and said pump sends the cleaning fluid F at said pressure P1 into each spray nozzle 22 associated with the sensors 31 to be cleaned.

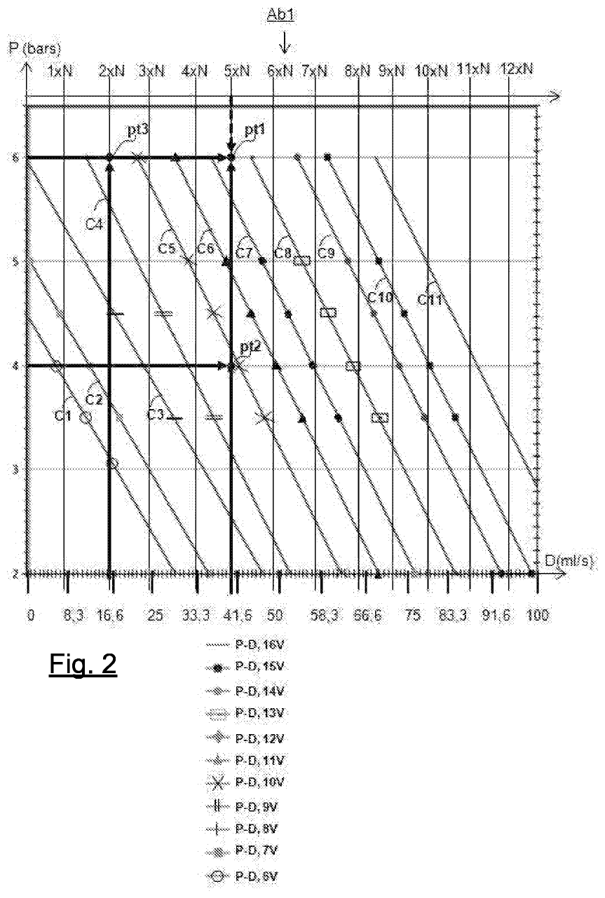

In non-limiting embodiments, the supply voltage U1 is adapted based on a chart Ab1 of various pressures per flow rate. FIG. 2 illustrates a non-limiting example of such a chart Ab1. The pressure P in bar is shown on the ordinate on the left and the flow rate D is shown in milliliters per second (ml/s) on the abscissa. The chart Ab1 has a plurality of straight lines Ci (i=1 to n, where n is an integer), which allows the supply voltage U1 to be determined that is to be applied to the cleaning pump 20 as a function of the desired pressure P1 for a given flow rate D of cleaning fluid F for all the sensors 31 to be simultaneously cleaned. In the non-limiting example illustrated in FIG. 2, the chart Ab1 thus provides eleven pressure/flow rate curves C1 to C11 for respective supply voltages U1 ranging from 6 V to 16 V with a step of 1 V. This yields the following pairs: C1/6 V; C2/7 V, C3/8 V, C4/9 V, C5/10 V, C6/11 V; C7/12 V, C8/13 V, C9/14 V, C10/15 V, C11/16 V. By virtue of the flow rate D, the chart Ab1 also shows the number N of sensors 31 to be simultaneously cleaned. Thus, it can be seen that, for D=40 ml/s, there are 5×N sensors 31. Thus, it can be seen that, for D=16 ml/s, there are 2×N sensors 31.

In the non-limiting example of five sensors 31 to be simultaneously cleaned, it can be seen from the chart Ab1 that for an operating point pt1 at 6 bar and 40 mL/s, the latter is close to the curve C7. The curve C7 corresponds to a supply voltage U1 of 15 V (Volts), which therefore will be applied to control the cleaning pump 20. The curve C7 closest to the operating point pt1 is therefore taken to determine the supply voltage U1 to be applied. Thus, the drive control unit 25 will configure the supply voltage U1 of the cleaning pump 20 to 15 V in order to obtain a pressure of 6 bar for a flow rate D of 40 mL/s. In another non-limiting example, for an operating point pt2 at 4 bar and 40 m L/s (in the case of five sensors 31), the supply voltage U1 will be 10 V. This corresponds to the curve C5 on the chart Ab1, which is closest to the operating point pt2. In another non-limiting example, for an operating point pt3 at 6 bar and 16 mL/s (in the case of two sensors 31), the supply voltage U1 will be 9 V. This corresponds to the curve C4 on the chart Ab1, which is closest to the operating point pt3.

Thus, it can be seen that, depending on the number N of sensors 31 to be simultaneously cleaned and on the required pressure P1, the cleaning pump 20 will not always operate at full power. Thus, this avoids emptying the storage tank 21 associated therewith too quickly.

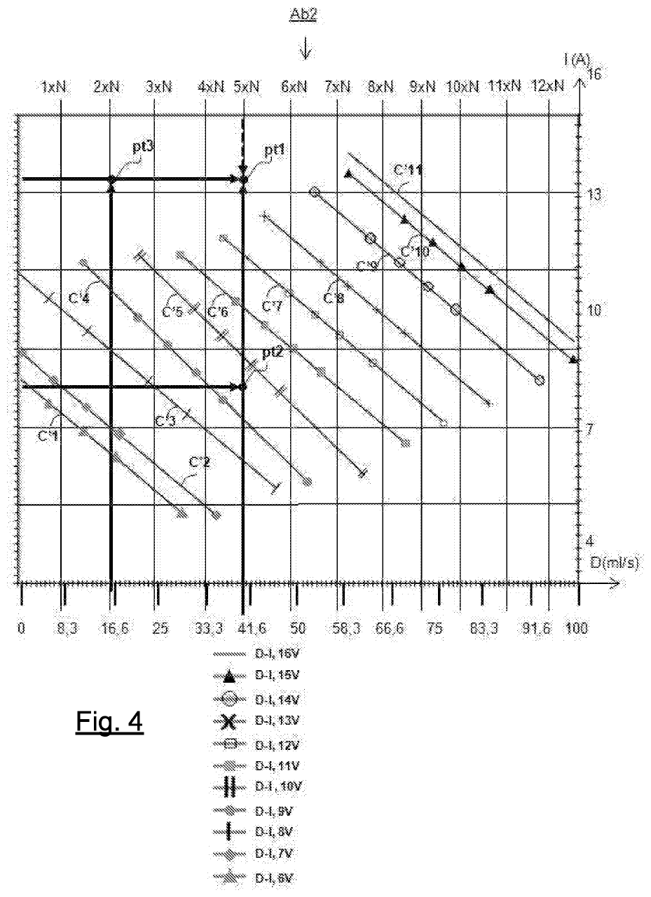

It should be noted that, when the pulse width modulation (PWM) signal has a duty cycle of 100%, the supply voltage U1 of said cleaning pump 20 corresponds to the voltage U2 of the battery 30 of the vehicle 3, i.e., 15 V in the non-limiting example provided. When the pulse width modulation (PWM) signal has a 50% duty cycle, the supply voltage U1 is equal to 7.5 V in the non-limiting example provided. It should be noted that adapting the supply voltage U1 as a function of the required pressure P1 and of the determined flow rate D allows the current consumption I of the cleaning pump 20 to be reduced. In the graph Ab2 illustrated in FIG. 4, the ordinate on the right shows the current consumption I in amperes (A), while the abscissa shows the flow rate D in milliliters per second (ml/s). The chart Ab2 has a plurality of straight lines C′i (i=to k, where k is an integer) that allow the consumed current I to be determined as a function of the determined flow rate D of cleaning fluid F for all the sensors 31 to be simultaneously cleaned. In the non-limiting example illustrated in FIG. 4, the chart Ab2 thus provides eleven flow rate/intensity curves C′1 to C′11 for respective supply voltages U1 ranging from 6 V to 16 V with a step of 1 V. This yields the following pairs: C′1/6 V; C′2/7 V, C′3/8 V, C′4/9 V, C′5/10 V, C′6/11 V; C′7/12 V, C′8/13 V, C′9/14 V, C′10/15 V, C′11/16 V. The operating points pt1, pt2 and pt3 are also shown in FIG. 4. Thus, as shown on the chart Ab2, for the five sensors 31 and the operating point pt1, the current consumption I is approximately 14 A (Amperes). In another non-limiting example, for the five sensors 31 and the operating point pt2, the current consumption I will be close to 9 A. In another non-limiting example, for the two sensors 31 and the operating point pt3, the current consumption I will be approximately 14 A. Thus, it can be seen that the current consumption I of the cleaning pump 20 varies as a function of the number N of sensors 31 to be simultaneously cleaned and on the required pressure P1. Thus, the cleaning pump 20 will not always be at its maximum current consumption I.

It should be noted that the flow rate values D are expressed in ml/s, as illustrated in FIGS. 2 and 4, and have been rounded down to the nearest decimal place. It should be noted that the flow rate D is expressed in ml/s as illustrated in FIGS. 2 and 4. However, it also can be expressed in L/min. In this case, the following matches are possible: 8.3 ml/s=0.5 L/min; 16.6 ml/s=1 L/min; 25 ml/s=1.5 L/min; 33.3 ml/s=2 L/min; 42.6 ml/s=2.5 L/min; 50 ml/s=3 L/min; 58.3 ml/s=3.5 L/min; 66.6 ml/s=4 L/min; 75 ml/s=4.5 L/min; 83.3 ml/s=5 L/min; 91.6 ml/s=5.5 L/min; 100 ml/s=6 L/min.

It should be noted that the ambient conditions can affect the cleaning fluid F. Notably, the outside temperature T (also called temperature T) affects the cleaning fluid F. Indeed, the lower the temperature T, the more viscous the cleaning fluid F and the harder it is to circulate in the pipes 23. Its flow rate D decreases. For example, at −10° Celsius, there will be half as much flow as at room temperature. In order to overcome the viscosity of the cleaning fluid F, the duty cycle of the pulse width modulation (PWM) signal must be increased. Thus, in one non-limiting embodiment, the supply voltage U1 is also adapted as a function of the temperature T. To this end, a multiplying correction coefficient is applied to the duty cycle of the pulse width modulation (PWM) signal after applying the chart Ab1. In one non-limiting embodiment, the multiplying correction coefficient is determined from a curve (not illustrated) that provides the value of the multiplying correction coefficient as a function of the temperature T.

Thus, the control method 1 allows the cleaning pump 20 to be voltage-controlled by means of a pulse width modulation (PWM) signal, as a function of sensor requirements, i.e., as a function of the number N of sensors 31 to be simultaneously cleaned, and of the required pressure P1. The external surfaces of the sensors 31 are thus cleaned correctly so that, notably, the functions for an autonomous or semi-autonomous motor vehicle 3 operate correctly. There is no risk of the external surfaces of the sensors 31 becoming so dirty that the autonomous or semi-autonomous motor vehicle 3 stops operating.

Thus, the control method 1 is implemented by the drive control unit 25. As illustrated in FIG. 3, said unit is configured for:
receiving at least one cleaning request Rq from at least one sensor 31 of said vehicle 3 (function f1 (25, 31, Rq));
determining a flow rate D of cleaning fluid F as a function of said at least one request Rq (function f2 (25,D(F));
adapting the supply voltage U1 of said cleaning pump 20 as a function of said flow rate D of cleaning fluid F, by means of a pulse width modulation (PWM) signal so as to provide a predetermined pressure P1 for said flow rate D of cleaning fluid F and to send said cleaning fluid F at said pressure P1 into a spray nozzle 22 associated with said at least one sensor 31 (function f3 (25, U1, PWM, D, T, P1(p1))).

It should be noted that, in one non-limiting embodiment, the drive control unit 25 is further configured to control the opening of the solenoid valve 240 associated with the spray nozzle 22 in order to allow said cleaning fluid F to pass into the pipe 23 connected to the relevant spray nozzle 22 (function f4 (25, 240, F)).

It should be noted that the cleaning system 2 can comprise one or more computer program products Pg comprising one or more sequences of instructions that can be executed by said drive control unit 25, with the execution of said sequences of instructions allowing the described control method 1 to be implemented.

A computer program Pg of this type can be entered in a non-volatile writeable memory of the ROM type, or in a non-volatile rewritable memory of the EEPROM or FLASH type. Said computer program Pg can be entered in the memory in the factory, or even loaded into the memory, or loaded into the memory remotely. The sequences of instructions can be sequences of machine instructions, or even sequences in a control language interpreted by the processing unit when they are executed. In the non-limiting example of FIG. 3, a computer program Pg is written in a memory 27 of the cleaning system 2.

Thus, the cleaning system 2 comprises at least one memory 27 that is coupled to said drive control unit 25 via a communication bus 29. The memory 27 is a non-transitory computer-readable storage medium comprising instructions, which, when they are executed by a computer, cause the computer to execute said control method 1.

Of course, the description of the invention is not limited to the embodiments described above and to the field described above. Thus, in one non-limiting embodiment, the supply voltage U1 is also adapted as a function of other ambient conditions such as, in one non-limiting example, the atmospheric pressure or the instantaneous weather conditions.

Thus, the invention that has been described notably has the following advantages:
it allows good cleaning efficiency to be provided, while guaranteeing the reliability of the cleaning pump 20 over time compared with the use of cleaning pumps in series;
it limits the current consumption I of the cleaning pump 20;
it limits the consumption of cleaning fluid F and prevents the storage tank 21 associated with the cleaning pump 20 from emptying too quickly;
it allows the sensors 31 to be cleaned quickly;
it is an inexpensive solution;
it is more efficient than a solution in which the cleaning pump is coupled to a pressure sensor that feeds back the pressure measured in the pipes to a drive control unit via a feedback loop. Indeed, in this case, the cleaning pump starts operating at full power (maximum supply voltage) and the spray nozzle starts cleaning the sensor with which it is associated. The pressure sensor can only measure the actual pressure when the cleaning fluid is flowing through the pipes. However, by the time the pressure builds up in the pipes, combined with the time it takes for the information from the pressure sensor to return to the drive control unit, combined with the time it takes to compute the correct supply voltage to be applied as a function of the measured pressure and the time it takes to send the supply voltage information to the cleaning pump, cleaning is already complete, as the duration for spraying the cleaning fluid F is very short (between 50 ms and 1 s).

What is claimed is:

1. A control method for controlling a cleaning pump for cleaning sensors of a vehicle, said control method comprising the following steps:
receiving at least one cleaning request from at least one sensor of said vehicle;
determining a flow rate of cleaning fluid as a function of said at least one cleaning request;
adapting the supply voltage of said cleaning pump as a function of said flow rate of cleaning fluid, by means of a pulse width modulation signal so as to provide a predetermined pressure for said flow rate of cleaning fluid and to send said cleaning fluid at said predetermined pressure into a spray nozzle associated with said at least one sensor.

2. The control method as claimed in claim 1, wherein the step of adapting the supply voltage occurs based on a chart of various pressures per flow rate.

3. The control method as claimed in claim 1, wherein, when the pulse width modulation signal has a duty cycle of 100%, the supply voltage of said cleaning pump corresponds to the voltage of the battery of the vehicle.

4. The control method as claimed in claim 1, wherein the adaptation of the supply voltage also occurs as a function of at least one ambient condition.

5. The control method as claimed in claim 1, wherein said at least one sensor is a lidar, a radar, or a camera.

6. The control method as claimed in claim 1, wherein the predetermined pressure is determined as a function of at least one static parameter.

7. The control method as claimed in claim 6, wherein said at least one static parameter is a distance between a spray nozzle and a sensor with which it is associated, a washing quality, the nature of the sensors, the total number of sensors.

8. The control method as claimed in claim 1, wherein the predetermined pressure ranges between 6 bar and 8 bar.

9. A computer program product comprising instructions which, when the program is executed by a computer, cause said computer to implement the steps of the control method as claimed in claim 1.

10. A non-transitory computer-readable storage medium comprising instructions which, when executed by a computer, cause the computer to execute the control method as claimed in claim 1.

11. A cleaning system for cleaning sensors of a vehicle, comprising:
at least one cleaning pump;
a plurality of spray nozzles;
a drive control unit, characterized in that said drive control unit is configured for:
receiving at least one cleaning request (Re) from at least one sensor of said vehicle;
determining a flow rate of cleaning fluid as a function of said at least one request;
adapting the supply voltage of said cleaning pump as a function of said flow rate of cleaning fluid, by means of a pulse width modulation signal so as to provide a predetermined pressure for said flow rate of cleaning fluid and to send said cleaning fluid at said predetermined pressure into a spray nozzle associated with said at least one sensor.

12. The cleaning system for cleaning the sensors of a vehicle as claimed in claim 11, wherein the drive control unit is further configured to control the opening of a solenoid valve associated with said spray nozzle to allow said cleaning fluid to pass through a pipe connected to said spray nozzle.
